(19) United States
(12) Patent Application Publication
(10) Pub. No.: US 2021/0216589 A1
(43) Pub. Date: Jul. 15, 2021

(54) INFORMATION PROCESSING APPARATUS, INFORMATION PROCESSING METHOD, PROGRAM, AND DIALOG SYSTEM

(71) Applicant: SONY CORPORATION, TOKYO (JP)

(72) Inventors: MARI IKENAGA, TOKYO (JP); KUNIAKI TORII, TOKYO (JP); KAZUNORI YAMAMOTO, TOKYO (JP); TAICHI YUKI, TOKYO (JP)

(21) Appl. No.: 17/059,822

(22) PCT Filed: May 20, 2019
(86) PCT No.: PCT/JP2019/019827

§ 371 Date: Nov. 30, 2020

(30) Foreign Application Priority Data
Jun. 6, 2018 (JP) 2018-108811

(51) Int. Cl. G06F 16/68; G06F 16/683; G10L 15/08; G10L 15/22

(52) U.S. Cl. CPC G06F 16/686; G06F 16/683; G10L 2015/225; G10L 15/22; G10L 2015/088; G10L 15/083

(57) ABSTRACT

An information processing apparatus of the present technology includes a control unit. The control unit acquires multimodal information including sound information and non-sound information of a user and determines a topic to be presented to the user on the basis of the multimodal information.

### TECHNICAL FIELD

The present technology relates to an information processing apparatus that enables an appropriate response to an input from a user, an information processing method, a program, and a dialog system.

### BACKGROUND ART

In the related art, a voice agent capable of handling a plurality of topics executes switching of the topics on the basis of information acquired from a user's utterance. However, in a case where a user utters a word that applies to the plurality of topics, it is difficult to correctly determine which topic the voice agent switches to.

Also, depending on a performance of voice recognition and semantic analysis, it is difficult for the voice agent to select the correct topic by using only sound information acquired from the user's utterance. For this reason, there is a problem in the art that because the voice agent frequently switches to a topic that is not intended for the user, a dialog between the user and the voice agent is mismatched and a user's feeling of use is reduced.

In view of this background, for example, Patent Literature 1 describes a technology for realizing a switching without a sense of discomfort for the user when the agent switches from one topic to another.

### CITATION LIST

### Patent Literature

Patent Literature 1: Japanese Patent Application Laid-open No. 2007-079397

### DISCLOSURE OF INVENTION

### Technical Problem

Thus, it is desired to improve response accuracy of the agent to the user's utterance.

In view of the above circumstances, it is an object of the present technology to provide an information processing apparatus that can improve the response accuracy to the user's utterance, an information processing method, a program, and a dialog system.

### Solution to Problem

In order to achieve the above object, an information processing apparatus according to an embodiment of the present technology includes a control unit.

The control unit acquires multimodal information including sound information and non-sound information of the user, and determines a topic presented to the user on the basis of the multimodal information.

This improves response accuracy of an agent by improving accuracy of selecting the topic to be presented to the user by the agent compared with a conventional case in which only the sound information acquired from the user's utterance is used, thereby improving the response accuracy of the agent.

The control unit may acquire the multimodal information including at least one of keyword information from the user or operation information of the user.

The control unit may list a plurality of candidate topics to be presented to the user from a history of topics uttered by the user in accordance with a predetermined rule corresponding to the keyword information or the operation information.

The control unit may assign an evaluation value to each of a plurality of topics uttered by the user in accordance with the predetermined rule, and may use a topic to which an evaluation value higher than those of other topics among the plurality of topics is assigned as a candidate topic to be presented to the user.

The control unit may acquire the multimodal information including biometric information that is information about a habit, a gesture, and a feature of the user.

The control unit may list a candidate topic to be presented to the user on the basis of a management table in which the biometric information is associated with the topic.

The control unit may assign an evaluation value to each of a plurality of topics in the management table, and may use a topic to which an evaluation value higher than those of other topics among the plurality of topics is assigned as a candidate topic to be presented to the user.

The control unit may calculate a third evaluation value from a first evaluation value calculated on the basis of the predetermined rule and a second evaluation value calculated on the basis of the biometric information, and determine a topic to be presented to the user on the basis of the third evaluation value.

The control unit may change response content with respect to the user depending on the third evaluation value.

This prevents the agent from misinterpreting a request of the user and reduces a sense of discomfort and an unpleasant feeling given to the user.

The control unit may be configured to be capable of acquiring feedback information from the user regarding a topic determined on the basis of the multimodal information.

The control unit may update the second evaluation value on the basis of the feedback information in a case where the feedback information is acquired.

The control unit may update the management table in a case where the control unit does not acquire the feedback information.

In order to achieve the above object, an information processing method according to one embodiment of the present technology includes

acquiring multimodal information including sound information and non-sound information from a user; and

determining a topic to be presented to the user on the basis of the multimodal information.

In order to achieve the above object, a program according to an embodiment of the present technology causes an information processing apparatus to execute steps of:

acquiring multimodal information including sound information and non-sound information from a user; and

determining a topic to be presented to the user on the basis of the multimodal information.

In order to achieve the above object, a dialogue system according to an embodiment of the present technology includes a multimodal device and an information processing apparatus.

The multimodal device generates multimodal information including sound information and non-sound information from a user.

The information processing apparatus includes a control unit that acquires the multimodal information from the multimodal device and determines a topic to be presented to the user on the basis of the information.

The multimodal device may include at least one of a microphone, an imaging apparatus, a smartphone, a wearable device, or a combination thereof.

### Advantageous Effects of Invention

As described above, according to the present technology, it is possible to provide an information processing apparatus that can improve response accuracy to a user's utterance, an information processing method, a program, and a dialog system. Note that the above effects are not necessarily limited, and any of the effects shown in the specification or other effects that can be grasped from the present specification may be achieved together with the above effects or in place of the above effects.

### BRIEF DESCRIPTION OF DRAWINGS

FIG. 1 is a block diagram showing an example of a hardware configuration of a dialog system according to the present embodiment.

FIG. 2 is a block diagram showing an example of a software configuration of an information processing apparatus.

FIG. 3 is a flowchart showing an information processing method of the information processing apparatus.

FIG. 4 is a diagram showing an example of a DOMAIN history.

FIG. 5 is a diagram showing an example of a management table.

FIG. 6 is a diagram showing an example of a DOMAIN transition rule.

FIG. 7 is a diagram showing an assignment of evaluation values to respective DOMAINs constituting the DOMAIN history.

FIG. 8 is a diagram showing an example of a table in which first to third evaluation values are summarized.

FIG. 9 is a diagram showing an example of a table in which feedback information and corresponding scores are summarized.

### MODES FOR CARRYING OUT THE INVENTION

Hereinafter, embodiments of the present technology will be described with reference to the drawings. The embodiments of the present technology will be described in the following order.

1. Overall Configuration

1-1. Hardware Configuration of Dialog System

1-2. Software Configuration of Information Processing Apparatus

2. Information Processing Method

3. Action

4. Modification

<Overall Configuration>

[Hardware Configuration of Dialog System]

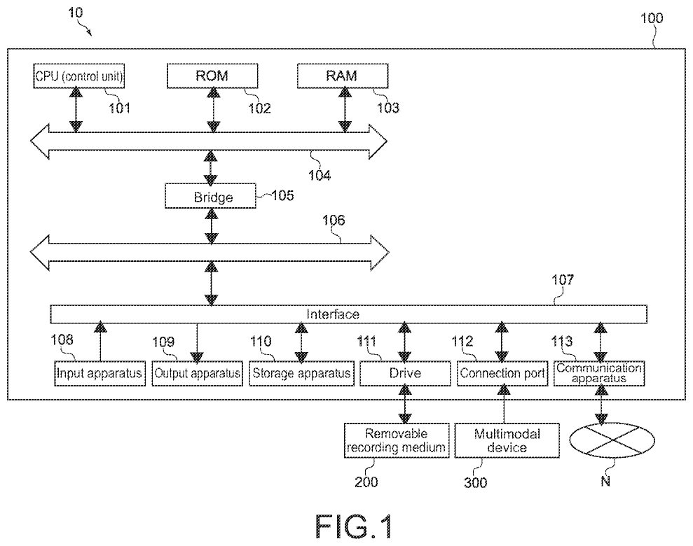

FIG. 1 is a block diagram showing an example of a hardware configuration of a dialog system 10 according to the present embodiment. As shown in FIG. 1, the dialogue system 10 includes an information processing apparatus 100 and a multimodal device 300.

(Information Processing Apparatus)

The information processing apparatus 100 includes a CPU (Central Processing Unit) 101, a ROM (Read Only Memory) 102, and a RAM (Random Access Memory) 103. The CPU 101 is an example of a “control unit” in Claims.

The information processing apparatus 100 may include a host bus 104, a bridge 105, an external bus 106, an interface 107, an input apparatus 108, an output apparatus 109, a storage apparatus 110, a drive 111, a connection port 112, and a communication apparatus 113.

Further, the information processing apparatus 100 may include processing circuits such as a DSP (Digital Signal Processor), an ASIC (Application Specific Integrated Circuit), and an FPGA (Field-Programmable Gate Array) instead of or together with the CPU 101.

In the present specification, it is assumed that the information processing apparatus 100 functions as an agent. Here, the agent refers to an apparatus that autonomously determines a user's intention by interpreting input information from the user and controls execution of processing according to the user's intention. In the present specification, it is assumed that the information processing apparatus 100 is an arbitrary computer, and the information processing apparatus 100 may be referred to as the agent.

The CPU 101 functions as an arithmetic processing apparatus and a control apparatus, and controls overall operation of the information processing apparatus 100 or a part thereof in accordance with various programs recorded on the ROM 102, the RAM 103, the storage apparatus 110, or the removable recording medium 200.

The ROM 102 stores programs and arithmetic parameters used by the CPU 101. The RAM 103 primarily stores a program used in executing the CPU 101, parameters that change accordingly in executing the program, and the like. The CPU 101, the ROM 102, and the RAM 103 are interconnected by a host bus 104 including an internal bus, such as a CPU bus. In addition, the host bus 104 is connected via the bridge 105 to the external bus 106 such as a PCI (Peripheral Component Interconnect/Interface) bus.

The input apparatus 108 is an apparatus operated by the user such as a mouse, a keyboard, a touch panel, a button, a switch, and a lever. The input apparatus 108 may be, for example, a remote control apparatus using infrared rays or other radio waves, or may be an externally connected device corresponding to the operation of the information processing apparatus 100. The input apparatus 108 includes an input control circuit for generating an input signal on the basis of information input by the user and outputting the generated input signal to the CPU 101. By operating the input apparatus 108, the user inputs various data to the information processing apparatus 100 or instructs a processing operation.

The output apparatus 109 includes an apparatus capable of notifying the user of the acquired information using a sense of vision, hearing, tactile sense, or the like. The output apparatus 109 may be, for example, a display apparatus such as an LCD (Liquid Crystal Display) or an organic EL (Electro-Luminescence) display, a sound output apparatus such as a speaker or headphone, or a vibrator. The output apparatus 109 outputs the result acquired by the processing of the information processing device 100 as a video such as a text and an image, a sound such as sound and audio, vibration, or the like.

The storage apparatus 110 is a data storage apparatus configured as an example of the storage unit of the information processing apparatus 100. The storage apparatus 110 includes, for example, a magnetic storage apparatus such as a Hard Disk Drive, a semi-conductor storage device, an optical storage device, a magneto-optical storage device, or the like. The storage apparatus 110 stores, for example, a program executed by the CPU 101, various data, and various data externally acquired.

The drive 111 is a reader/writer for a removable recording medium 200 such as a magnetic disk, an optical disk, a magneto-optical disk, or a semiconductor memory, and is built in or externally attached to the information processing apparatus 100. The drive 111 reads out the information recorded in the removable recording medium 200 and outputs the information to the RAM 103. Further, the drive 111 writes a record on the removable recording medium 200 mounted thereon.

The connection port 112 is a port for connecting the device to the information processing apparatus 100. The connection port 112 may be, for example, a USB (Universal Serial Bus) port, an IEEE1394 port, an SCSI (Small Computer System Interface) port, or the like. In addition, the connecting port 112 may be an RS-232C port, an optical audio terminal, an HDMI (High-Definition Multimedia Interface) port, or the like. By connecting the multimodal device 300 to the connection port 112, various data are output from the multimodal device 300 to the information processing apparatus 100.

The communication apparatus 113 is, for example, a communication interface including a communication device for connecting to the communication network N. The communication apparatus 113 may be, for example, a communication card for LAN (Local Area Network), Bluetooth (registered trademark), Wi-Fi, or WUSB (Wireless USB).

In addition, the communication apparatus 113 may be a router for optical communication, a router for ADSL (Asymmetric Digital Subscriber Line), or a modem for various types of communication. The communication apparatus 113 transmits and receives a signal and the like to and from the Internet or other communication device using a predetermined protocol such as TCP/IP. Further, the communication network N connected to the communication apparatus 113 is a network connected by wire or wireless, and may include, for example, the Internet, home LAN, infrared communication, radio wave communication, satellite communication, or the like.

(Multimodal Device)

The multimodal device 300 is configured to be capable of detecting information of a plurality of senses, such as five senses and somatosensory senses (balance sensation, spatial sense, etc.) of the user, and generates multimodal information including sound information and non-sound information of the user.

The multimodal device 300 of the present embodiment includes a combination of a plurality of types of devices, which includes, for example, at least one of a microphone, an imaging apparatus, a mobile terminal, a wearable device, or a combination thereof.

The microphone is configured to be capable of acquiring the sound information of the user (e.g., voice, hand-clapping sound, etc.). The imaging apparatus is, for example, an imaging element such as a CMOS (Complementary Metal Oxide Semiconductor or CCD (Charge Coupled Device), and an apparatus that images the user by using various members such as a lens for controlling imaging of a subject image to the imaging element and generates a captured image.

The imaging apparatus may capture a still image or may capture a moving image. The imaging apparatus is configured to be capable of acquiring non-sound information of the user (facial expression, identification information, line of sight, gesture information, and the like).

The mobile terminal is, for example, a smartphone, a mobile phone, a tablet terminal, or the like. The wearable device is configured to be capable of acquiring various types of information of the user (sweating, heart rate, pulse, breathing, blood pressure, blinking, gaze time, electroencephalogram, stress state, body temperature, physical condition (heat generation, cough), etc.) when being carried or operated by the user.

The wearable devices include, for example, HMD (Head Mounted Display), Smart Eyeglass, Smart Watch, Smart Band, Smart Earphones, and the like.

[Software Configuration of Information Processing Equipment]

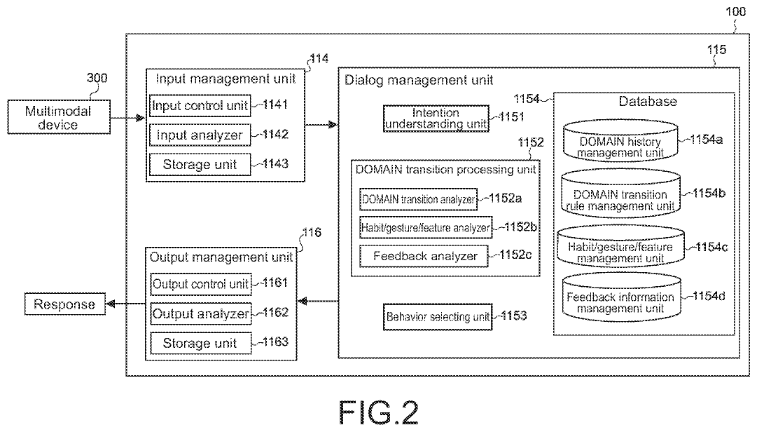

FIG. 2 is a block diagram showing an example of a software configuration of the information processing apparatus 100. The information processing apparatus 100 (CPU 101) functionally includes an input management unit 114, a dialog management unit 115, and an output management unit 116.

(Input Management Unit)

The input management unit 114 is a module that manages input information from the user or a peripheral environment in which the information processing apparatus 100 is placed. The input management unit 114 includes an input control unit 1141, an input analyzer 1142, and a storage unit 1143.

The input control unit 1141 manages the multimodal device 300 and input information from the multimodal device 300. The input analyzer 1142 is a module that analyzes information output from the input control unit 1141 and converts the information into information available for the agent.

The input analyzer 1142 analyzes information output from the multimodal device 300, for example, processing of analyzing sound information at a word level or processing of analyzing image sensing information. The storage unit 1143 is a storage area used when the input analyzer 1142 performs analysis.

(Dialogue Management Unit)

The dialog management unit 115 is a module for establishing a dialog with the user on the basis of the information output from the input management unit 114. The dialog management unit 115 includes an intention understanding unit 1151, a DOMAIN transitional processing unit 1152, a behavior selecting unit 1153, and a database 1154.

The intention understanding unit 1151 analyzes the information output from the input management unit 114, and analyzes the intention of what the user intends to speak.

The DOMAIN transition processing unit 1152 manages information linked with DOMAINs and lists a plurality of DOMAIN candidates to be presented to the user on the basis of the information output from the input management unit 114. In the present specification, the “DOMAIN” means a “topic” presented from the agent to the user, and the same applies to the following description.

In addition, the DOMAIN transition processing unit 1152 includes a DOMAIN transition analyzer 1152a, a habit/gesture/feature analyzer 1152b, and a feedback analyzer 1152c.

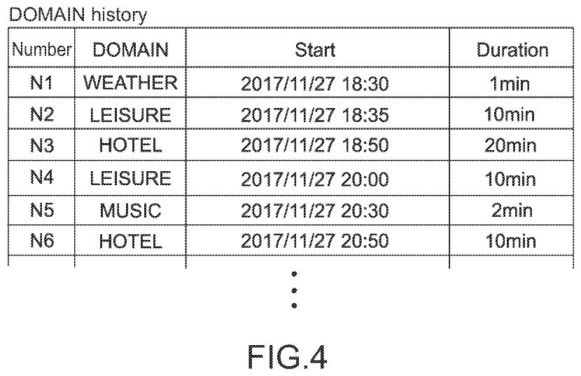

The DOMAIN transition analyzer 1152a extracts keyword information, gesture information, and the like from the information output from the input managing unit 114, and lists the plurality of DOMAIN candidates to be presented to the user on the basis of a DOMAIN history (see FIG. 4).

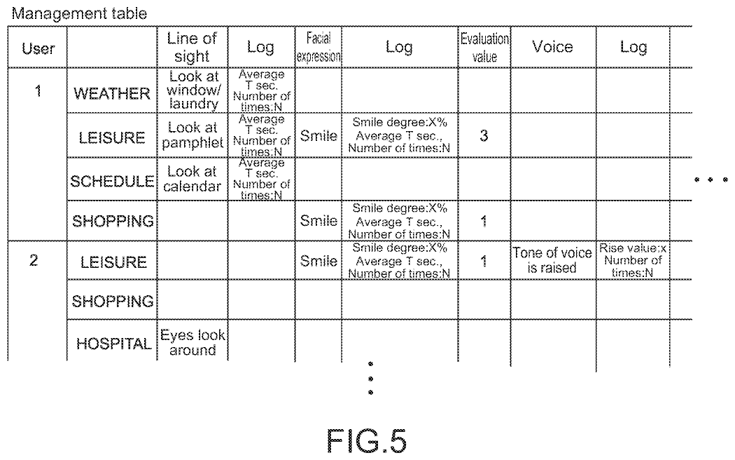

The habit/gesture/feature analyzer 1152b associates the DOMAINs presented to the agent by the user with a habit, a gesture, and a feature of the user, and registers them in the management table (see FIG. 5). In addition, the habit/gesture/feature analyzer 1152b extracts biometric information, which is information related to the habit, the gesture, and the feature of the user, from the information output from the input management unit 114, and lists the plurality of DOMAIN candidates to be presented to the user on the basis of the management table.

The feedback analyzer 1152c analyzes a feedback from the user on the basis of the information output from the input management unit 114.

The database 1154 holds information for appropriately responding to the user's utterance. The data base 1154 includes a DOMAIN history management unit 1154a, a DOMAIN transition rule management unit 1154b, a habit/gesture/feature management unit 1154c, and a feedback information management unit 1154d.

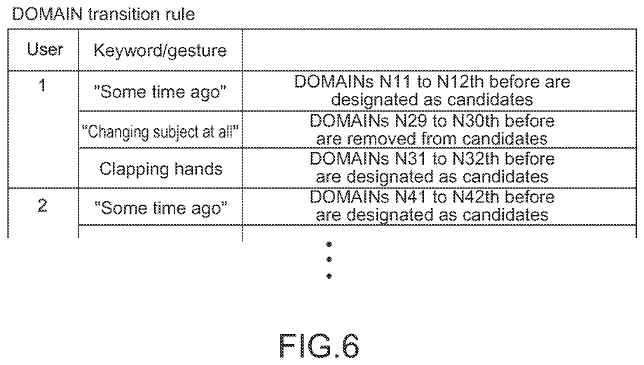

The DOMAIN history managing unit 1154a manages the DOMAIN history (see FIG. 4) presented by the user to the agent. The DOMAIN transition rule management unit 1154b manages a rule (see FIG. 6) of how long before the DOMAIN is to be transited (which topic is to be selected as a response to a request of the user) on the basis of the DOMAIN history for each user.

The habit/gesture/feature management unit 1154c manages the habit, the gesture, and the feature of the user while the user's utterance continues. The management table in which the DOMAIN is associated with the habit, the gesture, and the feature of the user is stored in the habit/gesture/feature management unit 1154c. The feedback information management unit 1154d manages the feedback from the user to the agent such as nodding, shaking a head horizontally, or the like.

(Output Management Unit)

The output management unit 116 is a module that manages information output from the dialog management unit 115. The output management unit 116 includes an output control unit 1161, an output analyzer 1162, and a storage unit 1163.

The output control unit 1161 controls the output apparatus 109 such as a display or a speaker. The output analyzer 1162 is a module that analyzes information output from the dialog management unit 115 and converts the information into information available for the output apparatus 109.

The storage unit 1163 is used as a work area for control of the output control unit 1161, a temporary storage space for information, and the like.

<Information Processing Method>

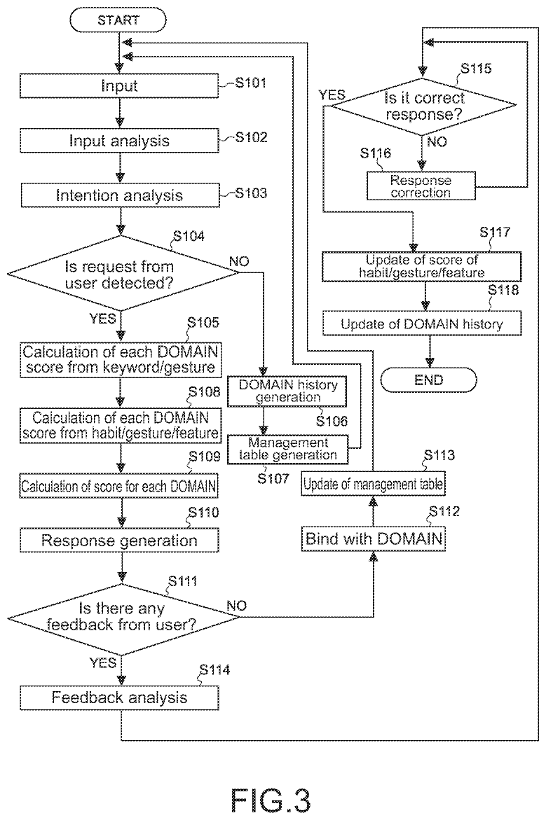

FIG. 3 is a flowchart showing an overall processing flow of the information processing apparatus 100. Hereinafter, an information processing method of the information processing apparatus 100 will be described with reference to FIG. 3, as appropriate.

(Step S101: Input)

First, multimodal information including sound information and non-sound information of the user detected by the multimodal device 300 is output to the input management unit 114. Here, the sound information includes sound input information (keyword information or the like) input to the input management unit 114, for example, by a user speaking to the agent when the multimodal device 300 includes a microphone.

In a case where the multimodal device 300 includes the imaging apparatus, the non-sound information includes, for example, information about the facial expression, the line of sight, the gesture, and the like of the user, identification information for individually identifying the user, the biometric information (information about habit, gesture, and feature of user), and the like.

Alternatively, the non-sound information may include information about sweating, heart rate, pulse, respiration, blood pressure, blinking, gaze time, brain wave, stress state, body temperature, and physical conditions (heat generation, cough), etc. of the user when the wearable device is included in the multimodal device 300.

(Step S102: Input Analysis)

The input management unit 114 (input analyzer 1142) that acquires the multimodal information from the multimodal device 300 analyzes the multimodal information, and the dialogue management unit 115 converts the multimodal information into available information. Then, the multimodal information after the conversion is output to the dialog managing unit 115 (intention understanding unit 1151, DOMAIN transition processing unit 1152).

(Step S103: Intention Analysis)

After acquiring the multimodal information from the multimodal device 300, the intention understanding unit 1151 analyzes this information, and analyzes the intention of the user, for example, what the user intends to speak.

(Step S104: Is Request from User Detected?)

In a case where the dialogue management unit 115 (DOMAIN transition analyzer 1152a) that acquires the multimodal information from the input management unit 114 detects the keyword information and the gesture information (operation information) from the request of the user included in the multimodal information (e.g., “Now, how is the weather of Maihama?”) or the like (Yes in Step S104), Step S105 described later is executed.

On the other hand, in a case where the dialogue management unit 115 (DOMAIN transition analyzer 1152a) does not detect the keyword information or the gesture information from the acquired multimodal information (NO in Step S104), the DOMAIN history (see FIG. 4) of what the user is speaking is continuously generated in accordance with the user's utterance (Step S106), and is stored in the DOMAIN history management unit 1154a. An exemplary DOMAIN history is shown in FIG. 4.

Next, the habit/gesture/feature analyzer 1152b associates the topic (DOMAIN) that the user is continuously speaking with the information about the habit/gesture/feature of the user (hereinafter, biometric information) detected at that time, and continuously constructs the management table (Step S107). The management table is stored in the habit/gesture/feature management unit 1154c. An example of such a management table is shown in FIG. 5.

Here, the keyword information is, for example, information about words such as “by the way”, “some time ago”, “changing a subject at all”, “just before”, “long before”, “now I remember”, “you know what”, and “that aside” included in the sound information (request) of the user.

Further, the gesture information is, for example, information about the operation of the user such as “clapping hands” or “raising an index finger” included in the non-sound information.

(Step S105: Calculation of Each DOMAIN Score from Keyword/Gesture)

The dialog management unit 115 (DOMAIN transition analyzer 1152a) extracts the keyword information or the gesture information from the multimodal information acquired from the input management unit 114. Then, in accordance with the DOMAIN transition rule corresponding to the information, a plurality of DOMAIN candidates to be presented to the user from the DOMAIN history is listed. An example of such a DOMAIN transition rule is shown in FIG. 6.

Specifically, an evaluation value is assigned to each of the plurality of DOMAINs constituting the DOMAIN history in accordance with the DOMAIN transition rule, and the DOMAIN having an evaluation value higher than that of other DOMAINs is designated as a candidate of the DOMAIN to be presented to the user.

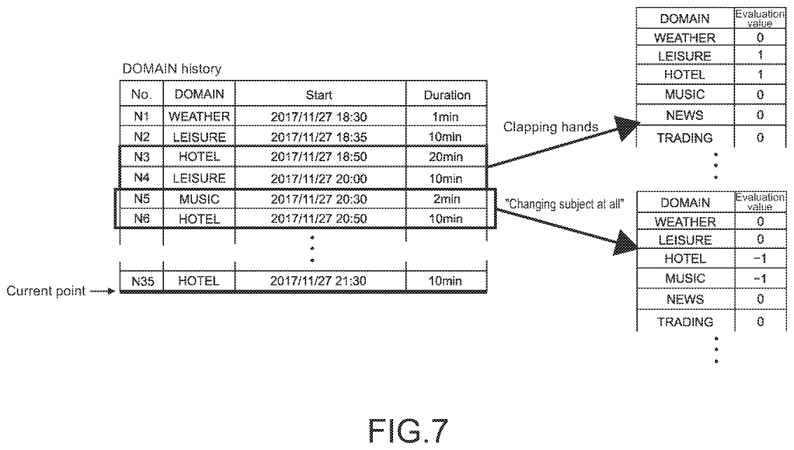

FIG. 7 is a conceptual diagram showing an assignment of evaluation values to the respective DOMAINs constituting the DOMAIN history. Referring to FIG. 7 as an example, in a case where the gesture information of “clapping hands” is extracted from the multimodal information, the DOMAIN transition analyzer 1152a assigns an evaluation value of “1” to the DOMAIN, for example, of 31 to 32rd from the current point of time in accordance with the DOMAIN transition rule corresponding to the gesture information of “clapping hands”, and assigns an evaluation value of “0” to other DOMAINs. In the embodiment of FIG. 7, since higher evaluation values are assigned to “LEISUIRE” and “HOTEL” of the DOMAINs than those of other DOMAINs, it means that these DOMAINs have been listed as candidates for the DOMAINs presented to the user.

On the other hand, in a case where the keyword information of “changing a subject at all” is extracted from the multimodal information, for example, the DOMAIN transition analyzer 1152a assigns an evaluation value of “−1” to the DOMAIN, for example, of 29 to 30rd from the current point of time in accordance with the DOMAIN transition rule corresponding to the keyword information of “changing a subject at all”, and assigns an evaluation value of “0” to other DOMAINs. In the embodiment of FIG. 7, since lower evaluation values are assigned to “HOTEL” and “MUSIC” of the DOMAINs than those of other DOMAINs, it means that these DOMAINs have been removed from candidates for the DOMAINs presented to the user.

(Step S108: Calculation of Each DOMAIN Score from Habit/Gesture/Feature)

The dialogue management unit 115 (habit/gesture/feature analyzer 1152b) extracts the biometric information of the user from the multimodal information acquired from the input management unit 114. Then, the habit/gesture/feature analyzer 1152b reads out the management table from the habit/gesture/feature management unit 1154c, and lists the DOMAIN candidates to be presented to the user on the basis of the management table.

Specifically, for each of the plurality of DOMAINs in the management table, an evaluation value is assigned on the basis of the extracted biometric information, and the DOMAIN to which an evaluation value higher than those of the other DOMAINs is assigned is designated as a candidate for the DOMAIN to be presented to the user. Note that the evaluation value assigned to each of the plurality of DOMAINs in the management table is calculated by, for example, formula (1) or (2) below.

$$\begin{matrix}( Math . 1 ) & \\ {T}_{i} = f ( {X}_{ijk} , {Y}_{i j} ) & ( 1 ) \\ ( Math . 2 ) & \\ {T}_{i} = {\sum }_{j , k} {a}_{j} ( {b}_{ijk} {X}_{ijk} + {c}_{ij} {Y}_{ij} ) & ( 2 )\end{matrix}$$

Xᵢⱼₖ in the formulae (1) and (2) represents an average number of seconds, the number of times, a point, etc. for each of the DOMAIN, the habit, the gesture, and the feature (i is index of DOMAIN, j is index of habit, gesture, feature (line of sight=0, face expression=1, voice=2, etc.), k is index of log type (second=0, number of times=1, rise value=2, etc.)). Yᵢⱼ represents a score for each of the DOMAIN, the habit, the gesture, and the feature. Also, f in the formula (1) represents a point calculation formula for each of the DOMAINs. In addition, aⱼ of the formula (2) (if extracted biometric information matches habit, gesture, and features in management table, aⱼ is 1; if they do not match, aⱼ is 0; etc.), and bᵢⱼₖ and cᵢⱼₖ represent coefficients.

Referring to FIG. 5 as an example, in a case where the biometric information such as “look at pamphlet” and “smile” is extracted from the multimodal information, the DOMAIN “LEISURE” is associated with the biometric information such as “look at pamphlet” and “smile” by referring to the management table, and therefore, the highest evaluation value is typically assigned to the DOMAIN “LEISUIRE”. In the example of FIG. 5, since the evaluation value higher than those of other DOMAINs is assigned to the DOMAIN “LEISURE”, it means that this DOMAIN is listed as a candidate for the DOMAIN presented to the user.

(Step S109: Calculation of Score for Each DOMAIN)

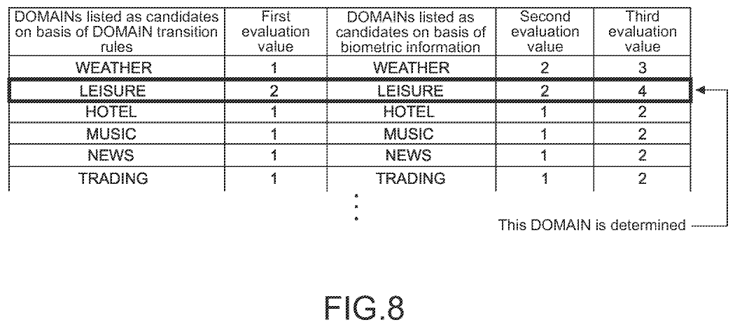

Next, the behavior selecting unit 1153 assigns an evaluation value (third evaluation value) to each of the plurality of DOMAINs listed as the candidates in the former Steps S105 and S108 using the evaluation value (first evaluation value) calculated on the basis of the DOMAIN transition rule and the evaluation value (second evaluation value) calculated on the basis of the biometric information of the user. An example of such a table in which the first to third evaluation values are summarized is shown in FIG. 8. Note that the third evaluation value assigned to each of the plurality of DOMAINs listed as the candidates is calculated by, for example, formula (3) or (4) below.

(Math. 3)

Pᵢ=g(Sᵢ,Tᵢ) (3)

(Math. 4)

Pᵢ=aᵢSᵢ+bᵢTᵢ (4)

Sᵢ of the formulae (3) and (4) is the first evaluation value (evaluation value of each DOMAIN acquired by DOMAIN transition rule), and Tᵢ is the second evaluation value (evaluation value of each DOMAIN acquired on the basis of biometric information). In addition, g in the formula (3) represents a point calculation formula for each DOMAIN, and aᵢ and bᵢ of the formula (4) represent coefficients.

Next, the behavior selecting unit 1153 determines the DOMAIN to which the highest evaluation value (third evaluation value) of the plurality of DOMAINs listed as the candidates is assigned as the DOMAIN to be presented to the user. In the embodiment of FIG. 8, this DOMAIN is determined as the DOMAIN presented to the user since the evaluation value higher than other DOMAINs is assigned to the DOMAIN “LEISURE”.

(Step S110: Response Generation)

Subsequently, the behavior selecting unit 1153 generates a response sentence to be presented to the user on the basis of the evaluation value (third evaluation value) assigned to the DOMAIN determined in the previous Step S109, and the agent returns the response according to the response sentence to the user. At this time, the behavior selecting unit 1153 changes response content with respect to the user depending on the magnitude of the evaluation value.

Specifically, if the highest evaluation value is P with 1 as the upper limit among the evaluation values (third evaluation value) assigned to the respective DOMAINs by the behavior selecting unit 1153, and if the evaluation value P falls within the range of a predetermined threshold (for example, K1≤P≤1), the behavior selecting unit 1153 determines that likelihood of the determined DOMAIN is sufficient and generates a response sentence having definite content in response to the request from the user (for example, “the weather of Maihama is fine”).

On the other hand, if the evaluation value P falls within the range lower than the threshold value K1 (for example, K2≤P<1), the behavior selecting unit 1153 determines that the likelihood of the determined DOMAIN is insufficient, and generates a response sentence having content that avoids a definite expression in response to the request from the user (for example, “Regarding the weather of Maihama, it is fine, etc.).

Furthermore, if the evaluation value P falls within the range lower than the threshold value K2 (e.g., K3≤P<K2), the behavior selection unit 1153 determines that the likelihood of the determined DOMAIN is further insufficient, and generates a response sentence having content that encourages the user to select the DOMAIN (for example, “you mean Maihama? Weather? or Hotel?” etc.). Alternatively, a response sentence is generated that asks the user to decide whether or not the DOMAIN to be presented for the user is correct (for example, “Is this the weather of Maihama?”).

In addition, if the evaluation value P falls within the range (0≤P<K3) below the threshold K3, the determined DOMAIN is not the DOMAIN to be presented to the user, and a response sentence having content that asks the user to restate or to explicitly inform the DOMAIN (for example, it responses such that “What about Maihama?”, and displays all DOMAIN candidates on the output apparatus 109 (display device) “(1) Weather, (2) HOTEL, (3) LEISURE . . . ” etc.).

(Step S111: Is there any Feedback from User?)

If there is feedback from the user to the response of the agent according to the response sentence generated in the previous Step S110 (Yes in Step S111), the information about this feedback (hereinafter, feedback information) is output to the DOMAIN transition processing unit 1152 (feedback analyzer 1152c) via the input management unit 114, and correctness of the response of the agent is determined.

On the other hand, if there is no feedback from the user to the response of the agent (NO in Step S111), the habit/gesture/feature analyzer 1152b associates the topic that the user is continuously speaking (DOMAIN) with the biometric information of the user detected at that time (Step S112), and updates the management table (see FIG. 5) (Step S113).

(Step S114: Feedback Analysis)

The feedback analyzer 1152c that acquires the feedback information via the input management unit 114 analyzes an attitude of the user with respect to the response of the agent.

Here, the feedback information is information about the attitude of the user to the response of the agent, and is, for example, information about the behavior of the user such as “nodding”, “further continue the same topic”, “shaking the head horizontally” and “frown face”. Alternatively, it is information related to the user's remarks such as “not true”, “not so”, and the like.

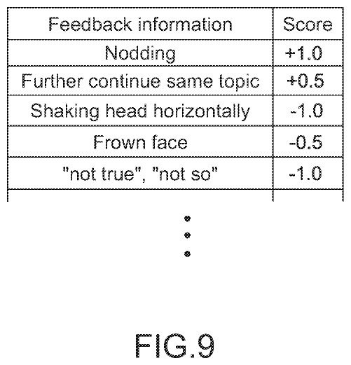

In this embodiment, scores are assigned to each of the feedback information as described above. The scores are used in Step S117 to be described later. FIG. 9 shows an example of a table in which the feedback information and the corresponding scores are summarized.

(Step S115: Is it Correct Response?)

If the response sentence (response of agent) generated in the previous Step S110 is a correct response to the request from the user (YES in Step S115), that is, if the feedback information indicating that the response is correct is acquired from the user in response to the agent, Step S117 described later is executed.

On the other hand, if the response of the agent is not the correct response to the request from the user (NO in Step S115), Step S116 described later is executed.

(Step S116: Response Correction)

If the response of the agent is incorrect for the user, the behavior selecting unit 1153 corrects the response sentence generated in the previous Step S110 and returns the response according to the corrected response sentence to the user. At this time, typically, the behavior selecting unit 1153 selects the DOMAIN to which the second largest evaluation value is assigned among the evaluation values (third evaluation values) assigned to the respective plurality of DOMAIN candidates (see FIG. 8), and generates the response sentence based on this DOMAIN.

(Step S117: Update of Score of Habit/Gesture/Feature)

In a case where the response of the agent is correct for the user, the behavior selecting unit 1153 adds the score corresponding to the feedback information from the user (see FIG. 9) to the evaluation value (second evaluation value) relating to the biometric information used at the time of the response of the agent, thereby updating the evaluation value assigned to each of the plurality of DOMAINs in the management table.

More specifically, it assumes that the user often looks at the pamphlet many times and smiles when the user is speaking about leisure, for example, in the past. In this case, the biometric information of the user such as “look at pamphlet” and “smile” is associated with the DOMAIN “LEISURE” and registered in the management table (see FIG. 5).

Then, for example, in response to a user's inquiry (request) that says “Disneyland?”, the agent detects the user's biometric information (look at pamphlet, smile) prior to the inquiry, selects “LEISURE” on the basis of the management table, and executes the response relating to this DOMAIN. Subsequently, as the feedback information of “nodding” is acquired from the user, when the user's biometric information of “look at pamphlet” or “smile” is detected after the next time, an evaluation value of, for example, one point larger than (1 point added) ever before is given to the DOMAIN “LEISURE” of the management table.

(Step S118: Update of DOMAIN History)

Next, when the agent executes the correct response to the user, the dialog management unit 115 adds the DOMAIN selected at the time of the response to the DOMAIN history (see FIG. 4). Also, if the agent executes the correct response after the previous Step S116, the DOMAIN selected at the time of correction is added to the DOMAIN history.

<Action>

The information processing device 100 according to the present embodiment extracts the keyword information or the gesture information and the biometric information from the multimodal information acquired from the user, and determines the DOMAIN to be presented to the user on the basis of the information. As a result, accuracy of a selection of the DOMAIN is improved compared with a conventional case in which only the sound information acquired from the user's utterance is used, thereby improving the response accuracy of the agent.

In addition, the information processing apparatus 100 changes the response content with respect to the user depending on the magnitude of the evaluation value assigned to each of the plurality of DOMAINs as the candidates to be presented to the user. This prevents the agent from misinterpreting the request of the user and reduces a sense of discomfort and an unpleasant feeling given to the user.

<Modifications>

Although the embodiments of the present technology have been described above, the present technology is not limited to the above-described embodiments, and various modifications may be made.

For example, in the above embodiments, the DOMAIN to be presented to the user is determined on the basis of the keyword information or the gesture information and the biometric information, but is not limited thereto, and the DOMAIN may be determined on the basis of information other than the above-described information. Such information may include, for example, identification information that identifies the user individually, information about sweating, heart rate, pulse, respiration, blood pressure, blinking, gaze time, brain wave, stress state, body temperature, and physical conditions (heat generation, cough), etc. of the user.

Furthermore, although the above embodiments have been described on the assumption that the user is a human, the present invention is not limited thereto, and, by using multimodal information (sound information and non-sound information) from non-human specimens (for example, animals such as dog, cat, rabbit, pig, horse, sheep, goat, poultry, and the like), a response to these specimens may be executed, and the application of the present technology is not particularly limited.

The present technology may also have the following structures.

(1)

An information processing apparatus, including:

a control unit that acquires multimodal information including sound information and non-sound information of a user, and determines a topic presented to the user on the basis of the multimodal information.

(2)

The information processing apparatus according to (1), in which

the control unit acquires the multimodal information including at least one of keyword information from the user or operation information of the user.

(3)

The information processing apparatus according to (2), in which

the control unit lists a plurality of candidate topics to be presented to the user from a history of topics uttered by the user in accordance with a predetermined rule corresponding to the keyword information or the operation information.

(4)

The information processing apparatus according to (3), in which

the control unit assigns an evaluation value to each of a plurality of topics uttered by the user in accordance with the predetermined rule, and uses a topic to which an evaluation value higher than those of other topics among the plurality of topics is assigned as a candidate topic to be presented to the user.

(5)

The information processing apparatus according to any one of (1) to (4), in which

the control unit acquires the multimodal information including biometric information that is information about a habit, a gesture, and a feature of the user.

(6)

The information processing apparatus according to (5), in which the control unit lists the candidate topic to be presented to the user on the basis of a management table in which the biometric information is associated with the topic.

(7)

The information processing apparatus according to (6), in

which the control unit assigns an evaluation value to each of the plurality of topics in the management table, and uses a topic to which an evaluation value higher than those of other topics among the plurality of topics is assigned as the candidate topic to be presented to the user.

(8)

The information processing apparatus according to (7), in which

the control unit calculates a third evaluation value from a first evaluation value calculated on the basis of the predetermined rule and a second evaluation value calculated on the basis of the biometric information, and determines the topic to be presented to the user on the basis of the third evaluation value.

(9)

The information processing apparatus according to (8), in which

the control unit changes response content with respect to the user depending on the third evaluation value.

(10)

The information processing apparatus according to any one of (1) to (8), in which

the control unit is configured to be capable of acquiring feedback information from the user regarding a topic determined on the basis of the multimodal information.

(11)

The information processing apparatus according to (10), in which

the control unit updates the second evaluation value on the basis of the feedback information in a case where the feedback information is acquired.

(12)

The information processing apparatus according to (10) or (11), in which

the control unit updates the management table in a case where the control unit does not acquire the feedback information.

(13)

An information processing method, including:

acquiring multimodal information including sound information and non-sound information from a user; and

determining a topic to be presented to the user on the basis of the multimodal information.

(14)

A program executable by an information processing apparatus, the program causing the information processing apparatus to execute steps of:

acquiring multimodal information including sound information and non-sound information from a user; and

determining a topic to be presented to the user on the basis of the multimodal information.

(15)

A dialogue system, including:

a multimodal device that generates multimodal information including sound information and non-sound information of a user; and

an information processing apparatus that includes a control unit that acquires the multimodal information from the multimodal device and determines a topic to be presented to the user on the basis of the information.

(16) The dialogue system according to (15), in which

the multimodal device includes at least one of a microphone, an imaging apparatus, a smartphone, a wearable device, or a combination thereof.

### REFERENCE SIGNS LIST

dialog system 10
information processing apparatus 100
CPU (control unit) 101
input manager 114
dialog manager 115
output manager 116
multimodal device 300

1. An information processing apparatus, comprising:
a control unit that acquires multimodal information including sound information and non-sound information of a user, and determines a topic presented to the user on a basis of the multimodal information.

2. The information processing apparatus according to claim 1, wherein
the control unit acquires the multimodal information including at least one of keyword information from the user or operation information of the user.

3. The information processing apparatus according to claim 2, wherein
the control unit lists a plurality of candidate topics to be presented to the user from a history of topics uttered by the user in accordance with a predetermined rule corresponding to the keyword information or the operation information.

4. The information processing apparatus according to claim 3, wherein
the control unit assigns an evaluation value to each of a plurality of topics uttered by the user in accordance with the predetermined rule, and uses a topic to which an evaluation value higher than those of other topics among the plurality of topics is assigned as a candidate topic to be presented to the user.

5. The information processing apparatus according to claim 4, wherein
the control unit acquires the multimodal information including biometric information that is information about a habit, a gesture, and a feature of the user.

6. The information processing apparatus according to claim 5, wherein
the control unit lists the candidate topic to be presented to the user on a basis of a management table in which the biometric information is associated with the topic.

7. The information processing apparatus according to claim 6, wherein
the control unit assigns an evaluation value to each of the plurality of topics in the management table, and uses a topic to which an evaluation value higher than those of other topics among the plurality of topics is assigned as the candidate topic to be presented to the user.

8. The information processing apparatus according to claim 7, wherein
the control unit calculates a third evaluation value from a first evaluation value calculated on a basis of the predetermined rule and a second evaluation value calculated on a basis of the biometric information, and determines the topic to be presented to the user on a basis of the third evaluation value.

9. The information processing apparatus according to claim 8, wherein
the control unit changes response content with respect to the user depending on the third evaluation value.

10. The information processing apparatus according to claim 8, wherein
the control unit is configured to be capable of acquiring feedback information from the user regarding a topic determined on a basis of the multimodal information.

11. The information processing apparatus according to claim 10, wherein
the control unit updates the second evaluation value on a basis of the feedback information in a case where the feedback information is acquired.

12. The information processing apparatus according to claim 10, wherein
the control unit updates the management table in a case where the control unit does not acquire the feedback information.

13. An information processing method, comprising:
acquiring multimodal information including sound information and non-sound information from a user; and
determining a topic to be presented to the user on a basis of the multimodal information.

14. A program executable by an information processing apparatus, the program causing the information processing apparatus to execute steps of:
acquiring multimodal information including sound information and non-sound information from a user; and
determining a topic to be presented to the user on a basis of the multimodal information.

15. A dialogue system, comprising:
a multimodal device that generates multimodal information including sound information and non-sound information of a user; and
an information processing apparatus that includes a control unit that acquires the multimodal information from the multimodal device and determines a topic to be presented to the user on a basis of the information.

16. The dialogue system according to claim 15, wherein
the multimodal device includes at least one of a microphone, an imaging apparatus, a smartphone, a wearable device, or a combination thereof.
